(19) United States
(12) Patent Application Publication
(10) Pub. No.: US 2007/0121561 A1
(43) Pub. Date: May 31, 2007

(54) WLAN MOBILE PHONE AND WIRELESS NETWORK

(76) Inventors: Haim Yashar, New York, NY (US); Abraham Shani, Nez Tziona (IL); Carmi Peleg, Moshav Shilat (IL); Dov Glikshtern, Kiryat Ono (IL)

Correspondence Address: JAECKLE FLEISCHMANN & MUGEL, LLP, 190 Linden Oaks, ROCHESTER, NY, 14625-2812, US

(21) Appl. No.: 11/561,086

(22) Filed: Nov. 17, 2006

Related U.S. Application Data
(63) Continuation-in-part of application No. 11/075,781, filed on Mar. 9, 2005.
(60) Provisional application No. 60/739,620, filed on Nov. 23, 2005.

(51) Int. Cl. H04Q 7/24

(52) U.S. Cl. 370/338

(57) ABSTRACT

A wireless network has a plurality of base stations, each configured to communicate with at least one portable device using a WLAN protocol. The wireless network also has a VoIP core network coupled to each of the base stations. A WLAN mobile phone has a VoIP processor coupled to an RF section and configured to monitor a current signal strength from a current base station and an alternate signal strength from an alternate base station, wherein the VoIP processor is configured to disassociate from the current base station when an analysis of the current signal strength and the alternate signal strength indicate that it would be better to associate with the alternate base station. A method of handing-off a VoIP call-in-progress from a first base station to a second base station with reduced interruption in voice communication is also disclosed.

### CROSS REFERENCE TO RELATED APPLICATIONS

This application claims priority to and is a continuation-in-part (CIP) of U.S. patent application Ser. No. 11/075,781 filed on Mar. 9, 2005 entitled “WIRELESS PACKET COMMUNICATIONS SYSTEM AND METHOD.” This application also claims priority to U.S. provisional patent application Ser. No. 60/739,620 filed on Nov. 23, 2005, entitled “WIFI MOBILE PHONE.” Both the Ser. No. 11/075,781 and the 60/739,620 applications are hereby incorporated by reference in their entirety.

### FIELD

The claimed invention is related to a system for mobile wireless IP phones which transmit and receive IP packets, and, more particularly, to wireless phones which transmit and receive IP packets and which emulate traditional cellular phones.

### BACKGROUND

Wireless local area networks (WLAN's) are being deployed in coffee shops, terminals, office buildings, campuses, homes, as well as other locations to obviate the need for a wired local area network connection for computers and other equipment that is networked. At the same time, software is being developed which can sample an analog conversation, code the conversation as a series of digital packets, and route the digital data over the internet to a recipient, where the digital data packets are uncoded and changed back into an analog signal which can be amplified for the recipient to hear. This type technology is referred to as voice-over-internet-protocol or VoIP teleology. Lately, companies have recognized the possibility that telephones can be developed with VoIP processors for coding and decoding voice data which can then be sent over the internet to a recipient while the VoIP phone user is connected to the network within a WLAN hotspot.

Unfortunately, the users of such VoIP telephones are limited to making their calls while staying within the relatively small WLAN hotspot, as compared to the freedom of movement afforded users of the currently more common cellular telephone. Current WLAN VoIP telephones encounter hand-off issues when moving from one coverage area or hotspot to another due to the conditions placed on the routing of IP data packets for voice. When transitioning from one WLAN coverage area to another, the currently available association process for the VoIP WLAN phones produces a noticeable void or interruption in voice conversations while the IP addressing and routing occurs.

This hotspot transition or hand-off issue is an even larger concern in a WLAN-based phone network, because transitions are more likely to occur. Since WLAN coverage areas are much smaller than the more conventional cellular wide area networks (WAN's) it will take many more WLAN coverage areas to create an overall coverage area to compete with the conventional cellular systems. Given this even larger number of WLAN areas, each covering a relatively small area, there exists a need for a wireless network and the related WLAN mobile phones which can utilize VoIP technology while reducing the hand-off delays when moving between hotspots so that voice conversations are not impacted by noticeable interruptions. If the current problem of noticeable WLAN hand-off interruptions can be solved, WLAN phone systems become attractive as an alternative to conventional cellular telephones, because they transmit IP data directly between the individual mobile phone, computer, or similar equipment (the client) and a base station (sometimes referred-to as an access point (AP)) while providing significantly higher data rates than conventional cellular systems available today or which will be available in the near future.

These problems, plus the present lack of additional features that cellular users are accustomed to and are not present in current WLAN mobile phone systems, will need to be overcome to make a commercially viable WLAN mobile phone and wireless network.

### SUMMARY

A wireless network has a plurality of base stations, each configured to communicate with at least one portable device using a wireless local area network (WLAN) protocol. The wireless network also has a Voice-over-IP (VoIP) core network coupled to each of the base stations.

A wireless local area network (WLAN) mobile phone has an antenna and an RF section coupled to the antenna. The WLAN mobile phone also has a VoIP processor coupled to the RF section and configured to monitor a current signal strength from a current base station and an alternate signal strength from an alternate base station, wherein the VoIP processor is configured to disassociate from the current base station when an analysis of the current signal strength and the alternate signal strength indicate that it would be better to associate with the alternate base station.

A method of handing-off a VoIP call-in-progress from a first base station to a second base station with reduced interruption in voice communication is disclosed. A determination is made that a call association should be changed from the first base station to the second base station. Identifying information about the second base station is stored before disassociating from the first base station. The first base station is disassociated from. An IP address assignment which was active when the call-in-progress was associated with the first base station is maintained. The second base station is associated with. The second base station is communicated with using the maintained IP address assignment.

### BRIEF DESCRIPTION OF THE DRAWINGS

FIG. 1 schematically illustrates an embodiment of a wireless network.

FIG. 2 schematically illustrates an embodiment of a wireless network having an embodiment of a repeater.

FIG. 3 schematically illustrates an embodiment of a wireless network having an embodiment of a voice gateway.

FIG. 4 schematically illustrates an embodiment of a wireless network having an embodiment of a fixed line gateway.

FIG. 5 schematically illustrates an embodiment of a wireless network having different embodiments of VoIP core network couplings.

FIG. 6A schematically illustrates another embodiment of a wireless network.

FIG. 6B schematically illustrates an embodiment of a sector for a base station of the embodied wireless network of FIG. 6A.

FIG. 6C schematically illustrates a top view of an embodiment of a 4-sector base station of the embodied wireless network of FIG. 6A.

FIG. 6D schematically illustrates an embodiment of the structure of a multi-sectored base station with N number of sectors.

FIG. 6E schematically illustrates an embodiment of a VoIP core network.

FIG. 7 illustrates one embodiment of a method of handing-off a VoIP call-in-progress from a first base station to a second base station with reduced interruption in voice communication.

FIG. 8 is a front view of an embodiment of a WLAN mobile phone.

FIG. 9 is a block diagram of a portion of the WLAN mobile phone embodied in FIG. 8.

FIG. 10 is a block diagram of a further portion of the WLAN mobile phone embodied in FIG. 8.

FIG. 11 illustrates one embodiment of a timing diagram of a WLAN mobile phone handoff process when the WLAN mobile phone roams from one sector connection (or base station connection) to another sector connection (or another base station connection) within a network.

It will be appreciated that for purposes of clarity and where deemed appropriate, reference numerals have often been repeated in the figures to indicate corresponding features, and that the various elements in the drawings have not necessarily been drawn to scale in order to better show the features of the invention.

### DETAILED DESCRIPTION

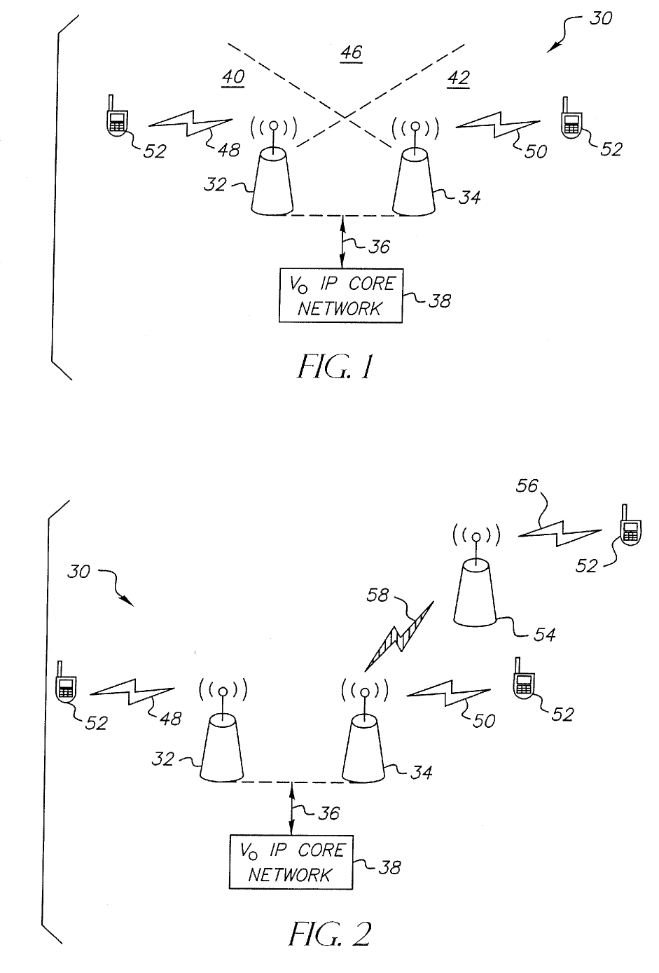

FIG. 1 schematically illustrates an embodiment of a wireless network 30. A first base station 32 and a second base station 34 are coupled 36 to a VoIP core network 38. Each base station 32, 34 has its own WLAN coverage area. In this embodiment, the first base station 32 has a first coverage area 40, and the second base station 34 has a second coverage area 42. The first and second coverage areas 40, 42 have an overlap coverage area 46. The base stations 32, 34 are configured to communicate 48, 50 with at least one portable device 52 using different frequency channels within a first frequency band. One example of a suitable first frequency band is approximately 2.4 GHz-2.5 GHz, such as would be used if the WLAN base stations were employing WiFi 802.11b or 802.11g. In other embodiments, different frequency channels and/or frequency bands could be used, for example, but not limited to, the 5.8 GHz frequency band. Since the base stations with overlapping coverage areas are preferably communicating on different channels, a portable device 52 can be configured to tell the difference between communications from one base station 32 and another 34.

Although only two base stations 32, 34 are illustrated in this embodiment, it should be understood that any plurality of base stations could be coupled to the VoIP core network 38. For simplicity, each base station is illustrated as having only one sector (one coverage area), but in other embodiments, a single base station can have a plurality of sectors by having separate sector antennas and processing circuitry for each sector on the same base station. One base station with a plurality of overlapping sectors or coverage areas would operate effectively like the two base station example above, but the separate coverage areas emanate from a single base station. Therefore, a plurality of base stations for the purposes of the claimed invention can also be made-up of a single base station having a plurality of overlapping sectors. A plurality of base stations can also mean one or more base stations, or any combination thereof.

The portable device 52 communicates with the at least one base station using a wireless local area network (WLAN) protocol. Examples of suitable protocols include, but are not limited to 802.11 (all variations), WiFi, and Bluetooth®. The portable device 52 and the base stations each preferably have an antenna which facilitates communication on the desired frequencies. In some embodiments, the portable device 52 can be a WLAN mobile phone, however, any mobile device which can also code and decode voice data for WLAN communication could be the portable device 52, such as, for example, a police radio in a police car. The portable device 52 does not only have to have WLAN communications capabilities. The portable device 52 could also have wireless wide area network (WWAN) capabilities, for example cellular GSM or cellular CDMA capabilities for when a WLAN connection was not available.

The VoIP core network 38 coordinates the overall wireless network. In an example communication, a portable device 52 associates with a base station 32 (also referred-to as an access point or AP). The portable device 52 can then register with the VoIP core network 38 via the base station 32. The VoIP core network 38 manages IP address assignments for each of the registered devices, tracks which base station the portable device is communicating through, and routes data to and from the portable device 52.

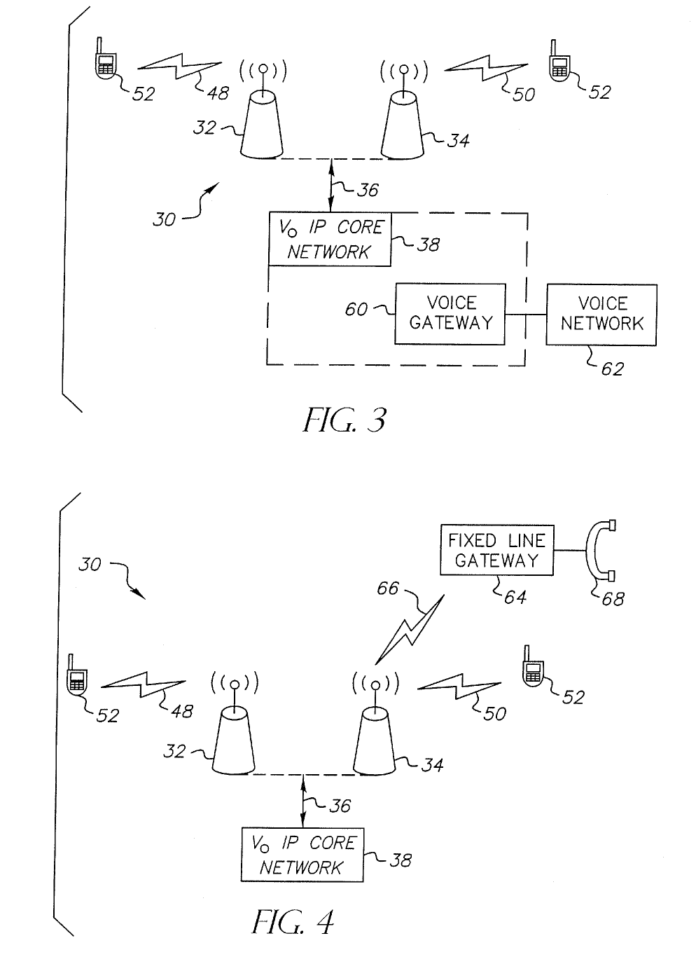

FIG. 2 schematically illustrates another embodiment of a wireless network. In this embodiment, a repeater 54 is added to the network 30 and is also configured to communicate 56 with a portable device 52 using the first frequency band which the base stations use. Relative to the communication 56 between the repeater 54 and the portable device 52, the repeater 54 acts just like a base station 32, 34 from the portable device's point of view. The repeater 54 creates at least one WLAN coverage area in the vicinity of the repeater 54. The repeater 54, however, is coupled to the VoIP core network 38 via a base station 34. In this embodiment, the repeater 54 communicates 58 with the base station 34 using a second frequency band so as not to interfere with the portable device communications on the first frequency band. For example, in some embodiments, the first frequency band might be the 2.4 GHz band and the second frequency band might be the 5.8 GHz frequency band, although other frequency bands can be chosen. A repeater 54 is useful for situations where base stations have trouble providing strong enough communication signals to the portable devices, such as within a building. Although only one repeater is shown in this embodiment, other embodiments may have a plurality of repeaters, either distributed separately at different base stations an-d/or set-up such that there is more than one repeater communicating with a single base station. Preferably, the portable device 52 should not be able to tell the difference between the repeater 54 and a base station 32. The portable device 52 can register with the VoIP core network 38 via the repeater 54 through the base station 34.

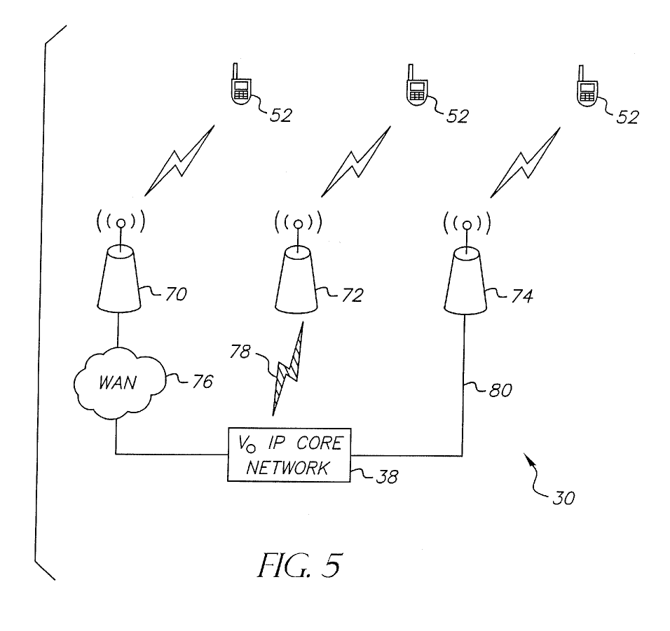

The embodiments described thus far enable one portable device 52 to communicate with another portable device 52, provided the two devices are both registered with the VoIP core network 38. In other embodiments, it may be desirable for a portable device 52 registered with the VoIP core network 38 to be able to communicate with a network outside of the wireless VoIP network 30. FIG. 3 schematically illustrates another embodiment of a wireless network 30 which addresses this situation. In the embodiment of FIG. 3, the VoIP core network 38 has or is connected to a voice gateway 60 which is capable of coding and decoding voice data appropriately for communication with a voice network 62 that is separate from network 30. Although only one voice network 62 is illustrated in this embodiment, other embodiments may be configured to allow the VoIP core network 38 to communicate with a plurality of other voice networks using one or more voice gateways 60. Examples of voice networks 62 which a voice gateway 60 could connect to include, but are not limited to, a cellular communication system, such as GSM or CDMA; a private branch exchange (PBX) system; and a circuit-switched calling system such as a public switched telephone network (PSTN).

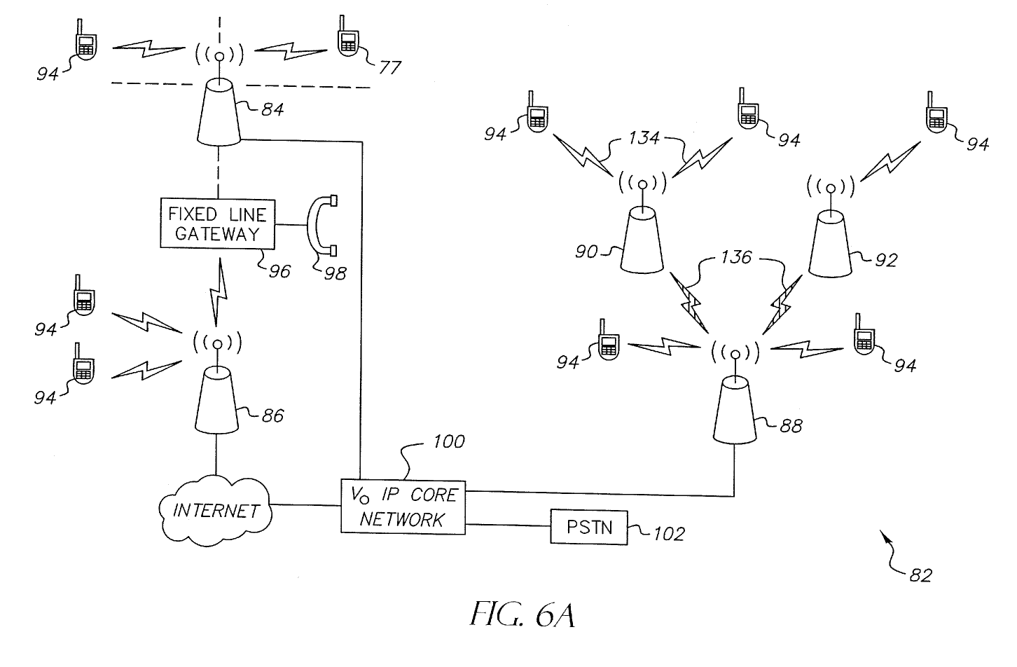

In other embodiments, it may be desirable to allow fixed telephone lines to communicate over the wireless network 30 without having to connect the fixed telephone lines over a separate voice network 62. FIG. 4 schematically illustrates an embodiment of a wireless network which addresses this situation. A fixed line gateway 64 is provided to communicate 66 with a base station 34 similar to how a portable device 52 would communicate with the base station 34 over the first frequency band. In addition to having this WLAN communication capability, the fixed line gateway 64 is also coupled to a fixed line telephone 68. The fixed line gateway 64 can register the fixed line telephone 68 with the VoIP core network 38 for communications on the wireless network 30. The fixed line gateway 64 also handles the coding and decoding necessary to translate between the fixed line phone 68 voice format and the VoIP packet format. Although only one fixed line gateway 64 is illustrated in the embodiment, other embodiments can have a plurality of fixed line gateways communicating with one or more base stations. Furthermore, in other embodiments, a single fixed line gateway 64 may be configured to connect more than one fixed line telephone 68 to the wireless network 30.

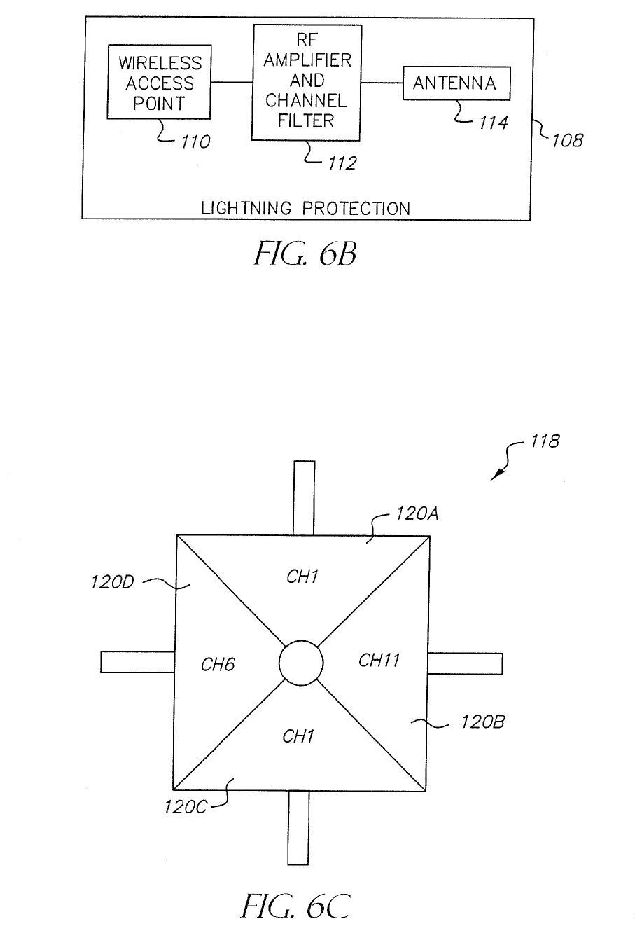

The VoIP core network 38 may be coupled to the base stations in a variety of ways. FIG. 5 schematically illustrates an embodiment of a wireless network 30 which illustrates some of the possible couplings. In this embodiment, three separate base stations 70, 72, 74 are provided for WLAN communication with portable devices 52. Base station 70 is coupled to the VoIP core network 38 via a wide area network (WAN) 76. An example of a suitable WAN 76 includes the internet. As an alternate, base station 72 is coupled to the VoIP core network 38 via a local area network (LAN), such as a wireless LAN 78. As a further alternate, base station 74 is coupled to the VoIP core network 38 via a wired connection 80. The wired connection can be either electrically conductive wires or one or more fiber optic wires. Although only one base station is shown connecting to the VoIP core network 38 for each example coupling method in the embodiment of FIG. 5, in other embodiments there can be multiple base stations connecting via similar coupling methods.

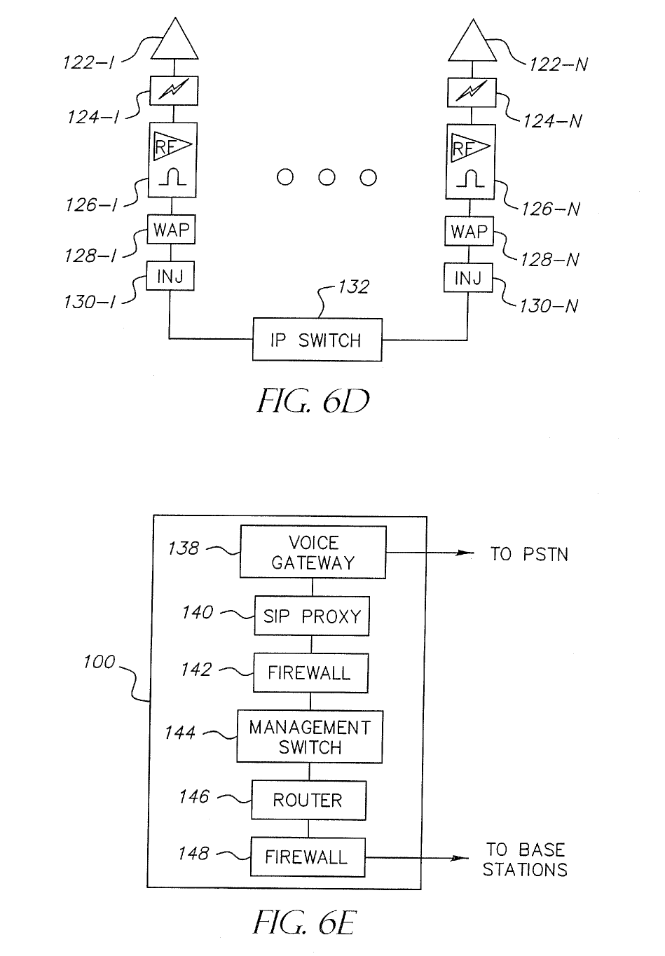

The embodiments of wireless networks in FIGS. 1-5, and their equivalents, can be combined in various ways to create different configurations of wireless networks. FIG. 6A schematically illustrates one embodiment of such a combination. Like the previous embodiments, this embodiment enables VoIP services similar to existing cellular technologies, but with the much higher data rates WLAN-based access provides, while reducing the interruptions in the voice communication which occur when switching from one antenna coverage area to another. The system of this embodiment combines a portable, cellular-style phone with a WLAN wireless radio network operating on the 2.4 gigahertz open frequency band and using the 802.11b/g protocols. As mentioned earlier, other embodiments may use other frequency bands and other WLAN protocols.

The wireless network 82 has WLAN base stations 84, 86, and 88 operating on the 2.4 gigahertz open frequency band and using the 802.11b/g protocols. The base stations may be installed on house/building rooftops, on towers, on poles, on trees, etc. in accordance with an area's layout, in order to allow optimal reception for defined areas. The wireless network also has repeaters 90, 92 which can be used to cover areas where wireless coverage is not sufficient, such as inside buildings. The repeaters 90, 92 may be connected via wires or wirelessly to a base station.

This embodiment provides two types of end-user devices which allow a user to hold a phone conversation. One end-user device is a unique wireless phone 94 which operates on the 2.4 gigahertz open frequency and uses the 802.11b/g protocols, on SIP standard. Another type of end-user device is the combination of a fixed line VoIP gateway 96 plus a fixed-line phone 98. In this embodiment, the fixed line VoIP gateway 96 uses 802.11b/g protocols, on SIP standard to provide fixed line VoIP for a standard fixed-line phone 98.

This embodiment also has a VoIP Core Network unit 100 which provides VoIP services and which is coupled to a PSTN 102 of a national telephone system.

The base stations 84, 86, 88 may be used to transmit and receive to and from the end-units 94, 98. In this embodiment, each base station is a modular unit of up to 4 sectors made possible with one or more sector antennas. For example, base station 84 has two sectors 104 and 106. The number of sectors for each base station is determined in concordance with the coverage needs of a given area. In other embodiments, the one or more sectors can be of any desired size and coverage shape by changing the characteristics of the sector antenna. In this embodiment, the sector antennas are modular, and each sector arbitrarily covers a 90 degree area. Therefore, in this embodiment, a four sector base station is used for 360 degree coverage. The transmission range of each sector can reach up to two kilometers in an open spaced area and five hundred to seven hundred and fifty meters in a built up area.

As mentioned earlier, a base station can have one or more sectors. FIG. 6B schematically illustrates an embodiment of a sector 108. The sector 108 has a wireless access point 110, for example a Cisco wireless access point (model AIR-BR-1310G) with a 100 mw transmission capacity. FCC: LDK102052P approval. The wireless access point 110 sends and receives data packets. An RF amplifier and channel filter 112 is coupled to the wireless access point 110. An example of a suitable RF amplifier and channel filter 112 is manufactured by RF-LINX with volumes of between 125 mw and 1 watt, together with a filter channel which allows for changing channel selection from channel 1 through channel 11. An antenna 114 is coupled to the RF amplifier and channel filter 112. Those skilled in the art can select a variety of antenna designs which will fulfill a desired sector pattern. One example of a suitable antenna 114 is a multi-polarized antenna with 9.2 dBi transmission intensity and −97 dB reception sensitivity. The sector 108 also has lightning protection 116.

In this embodiment, in order to help increase performance and avoid interference, each sector is allocated with one of three non-over lapping channels 1, 6, and 11. At a four sector base station, identical channels will be placed in opposite directions. For example, FIG. 6C schematically illustrates a top view of an embodiment of a 4-sector base station 118, having sectors 120A, 120B, 120C, and 120D. In this embodiment, opposite sectors 120A and 120C are set to channel 1 since these sectors 120A and 120C are positioned not to interfere with each other. Intervening sectors 120B and 120D are set to channels 11 and 6 respectively. Other embodiments may use other channel choices, different numbers of sectors, and/or different sector antenna patterns. While constructing a wireless network with multiple base stations, it is desirable to avoid a situation where identical channels will overlap, in order to decrease the possibility of mutual disturbances.

FIG. 6D schematically illustrates the structure of a multi-sectored base station with N number of sectors. Each sector has an antenna 122 with lighting protection 124 coupled to an RF amplifier and channel filter 126 coupled to a wireless access point 128 coupled to an access point injector 130. The access point injectors 130-1 to 130-N are then coupled to an IP switch 132 which helps direct traffic to/from the base station.

As described already with regard to FIG. 6A, the wireless network 82 has at least one repeater 90, 92. The repeater is intended to assist coverage in areas where base station transmission and reception is insufficient (mainly inside buildings). In this embodiment, each repeater has an access point, and two antennas, one for communication 134 (See FIG. 6A) with the end-use equipment 94, and one for communication 136 with the adjacent base station 88. One embodiment of a suitable repeater can include a wireless access point unit, model WX-7800A by Spark Lan with FCC RYK—7800A approval. The two antennas can suitably be, for example, two multi-directional antennas, each with 8 dBi transmission intensity, Model No. OAN-2080, by Level One. In this embodiment, each repeater 90, 92 has the following characteristics: a transmission capacity of 100 mw (mw200 EIRP), using a protocol of 802.11a/b/g, with a data transfer rate of up to 54 Mbps.

The end-user handset 94 in this embodiment is an 802.11b/g protocol mobile phone that operates in much the same way that a cellular phone would from the user's point of view. The handset 94, however is communicating using VoIP, using the SIP standard in this embodiment. The phone handset 94 is designed to work through a provider's network of base stations in addition to WiFi “hot spots”. In a preferred embodiment, the WLAN mobile phone 94 has a maximum transmission strength capable of reaching up to mw600 (EIRP), although other transmission strengths may be used in other embodiments. In some embodiments, the phone 94 sets the transmission strength automatically, according to the local wireless network's reception strength in order to help conserve the handset's battery when possible. In this embodiment, the WLAN mobile phone has a reception sensitivity of −97 dB.

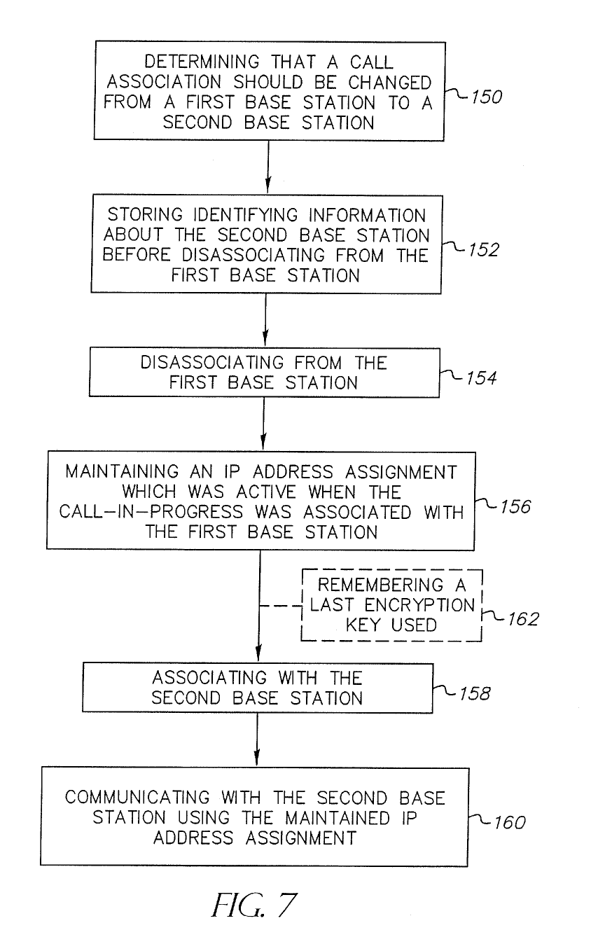

The handset 94 is configured to allow users to conduct conversations within the network, while on the move between sectors and between base stations without disturbances and disconnections. This will be discussed in greater detail later with regard to FIG. 7. Although the handset specifications in other embodiments may vary, the handset specifications in this embodiment are as follows:

| | |
|---|---|
| Conversation Protocol | SIP, SIP 2 |
| Wireless Transmission Protocol | 802.11b/g |
| Encoding | WEP-64/128, WPA-PSK, WPA, WPA2 |
| Frequency | 2.4 GHz |
| Antenna | 2.5 dBi |
| Quality of Service | 802.11e Protocol |
| Encryptor | Encryption code G711-A G711H G729 |
| Battery | 4 Hours talk time, 100 Standby Hours |
| Operating System | Linux |
| Transmission Capacity (EIRP) | 100 mW to 600 mW |
| Reception Sensitivity | −97 dB |
| Capacity Management | PMU system for transmission capacity |
| | management |

The VoIP core network 100 in this embodiment has a voice gateway which allows for a connection between the base station and a standard phone line, for example on a PSTN 102, and for conversion from a regular vocal signal from the PSTN 102 to a digital signal and visa versa. The VoIP core network 100 takes care of all phone call related issues and connections with other operators. FIG. 6E schematically illustrates one embodiment of a VoIP core network 100. In this embodiment, the VoIP core network 100 has a voice gateway 138 for coupling to an external telephone network, such as a public switched telephone network (PSTN). The voice gateway 138 is coupled to a SIP proxy server 140 for managing the IP registration and packet sessions. A firewall 142 is coupled to the SIP proxy 140, followed by a management switch 144, router 146, and firewall 148, all of which help the VoIP core network 100 communicate with specific base stations. The VoIP core network 100 is coupled to the base stations by a variety of different methods which have been discussed above with regard to other embodiments.

Referring again to the embodiment of FIG. 6A, when the end-user turns on the wireless handset 94 within the network's coverage area, the phone 94 executes an identification and connection process, and registers with the VoIP core network 100. After the identification, connection, and registration are completed successfully, the phone 94 is ready for action.

The wireless phone 94 scans the coverage area for existing networks within range. Although not illustrated, there may be competing VoIP networks with their own base stations and separate VoIP core network within range of an end-user's phone 94. In this embodiment, the phone is associated with a default preference for a VoIP wireless network. If the default network is not found, the phone will connect to another network in accordance with a user-defined preferred network list. If defined networks are not found the user can manually initiate a network search and connect to any other available and compatible networks.

At the end of the network search, the phone displays the name of the chosen network, and executes a connection and registration with the core network using the IP address embedded within the phone as defined by the phone provider. Phone numbers, user names and passwords may be registered with the VoIP core network 100 for identification purposes. When the phone 94 is connected to the VoIP core network 100 a phone number associated with the phone 94 can be displayed on the handset screen.

When the user desires to make a call, the user dials the desired number or, alternatively, accesses his phone's stored numbers and sends a “call” request. The request containing the phone number goes through to the VoIP core network 100 and from there to the national telephony system 102 or internal network system 100 while the voice data is converted from an analog signal to a digital signal or visa versa as needed.

The embodied wireless VoIP networks discussed herein are more than just a plurality of single WLAN networks which are capable of communicating VoIP data. The VoIP core network and the portable devices connecting to the base stations are configured to allow a VoIP call-in-progress to be handed-off from a first base station or sector to a second base station or sector with a reduced interruption in the voice communication, where ideally, the end-user is not even aware of the transition. In some embodiments, a reduced interruption in the voice communication may even mean an eliminated interruption in the voice communication.

FIG. 7 illustrates one embodiment of a method for handing off a VoIP call-in-progress from a first base station to a second base station with reduced interruption in the voice communication. It should be understood from the preceding discussion of base stations and sectors, that the method which applies to transitions from one base station to another base station is also intended to apply to transitions between different sectors of the same base station. Such sector transitions are effectively transitions between different base stations.

The starting situation where the method of FIG. 7 applies is after a VoIP call has been initiated via a first base station. As part of the call initiation, an access point (AP) association and an AP authentication are made via the communication channel of the first base station. The phone transmits and receives via a first channel, and a SIP call initiation and an IP address assignment are made with the VoIP core network. At this point, the VoIP call is in progress. According to the embodied method of FIG. 7, while the call is in progress, a determination 150 is made that a call association should be changed from a first base station to a second base station. The phone is configured to monitor other channels beyond the channel currently in use. In doing so, the signal strengths of various available channels can be compared. In some embodiments, these signal strengths can be used to make the determination 150 that the call association should be changed, for example by comparing the first and current signal strength to a second and alternate signal strength to see if the second signal strength exceeds the first signal strength by a threshold. A suitable threshold for some embodiments may be 3 dB. Other thresholds and/or comparison methods may be used in other embodiments.

Identifying information is stored 152, in the portable wireless device, about the second base station before disassociating from the first base station so that after the determination 150 is made to change association from a first base station to a second base station, the phone will know how to contact the second base station. An example of suitable information to be stored 152 about the second base station is a MAC address of the second base station. Next, the phone disassociates 154 from the first base station. Despite the disassociation, the IP address assignment which was active when the call-in-progress was associated with the first base station is maintained 156. The VoIP core network can be configured to maintain this address assignment for a desired delay time to allow the phone to associate 158 with the second base station. This is a major improvement beyond previous VoIP phone systems, since in previous systems the IP address would have to be re-assigned as a result of the 802.11 protocols running in separate WLAN's without coordination. The delay in these previous systems from the IP address re-assignment is noticeable to the end-user as a gap in the conversation. By associating 158 with the second base station while the IP address is maintained 156, the time delay for the AP disassociation from the first base station combined with the time delay for the AP association and AP authentication to the second base station can be short enough to be imperceptible to the end-user. After associating 158 with the second base station, the phone continues communicating 160 with the second base station using the maintained IP address. In some embodiments, as part of maintaining the IP address assignment, the peer-to-peer connection which was active when the call in progress was associated with the first base station is also maintained. This peer-to-peer connection can be a SIP call in some embodiments. In other embodiments the method can also include a remembering action, where a last encryption key used with the first base station is remembered 162 so that encrypted communications may more quickly be reestablished when associating with the second base station.

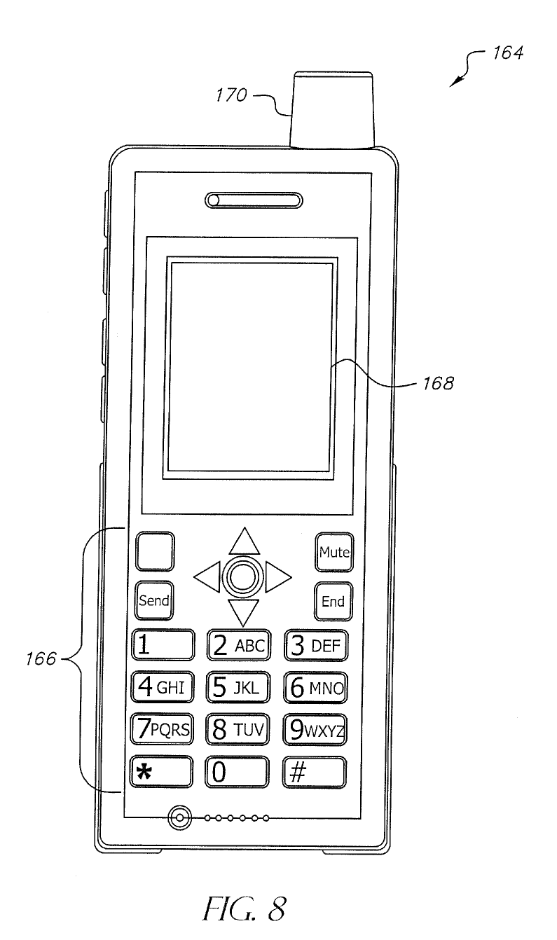

FIG. 8 is a front view of one embodiment of a WLAN mobile phone 164 which could be used with the embodied wireless networks described herein, and their equivalents. The WLAN mobile phone 164 includes a key pad 166, a display 168, and a radome 170. As mentioned previously, from the end-user's point of view, the WLAN mobile phone 164 operates in a manner that emulates a cellular phone. That is, a user with knowledge of how to use a cellular phone would operate the WLAN mobile phone 164 in essentially the same manner.

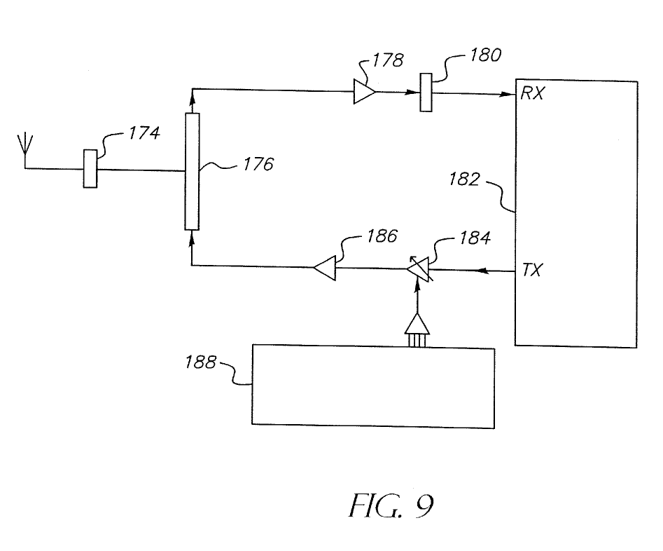

FIG. 9 is a block diagram of a portion of the embodied WLAN mobile phone 164 shown in FIG. 8. The antenna 172 is coupled through a low pass filter 174 to a transmit/receive (T/R) switch 176. Received signals from the T/R switch 176 are amplified in a low noise amplifier (LNA) 178, the output of which is coupled through a balun 180 to the RX terminal of a transceiver 182, which may be a BCM4318E manufactured by the Broadcom Corp. of Irvine, Calif.

The RF output of the transceiver 182 at terminal TX is coupled through a driver amplifier 184, the output of which is amplified by a power amplifier 186 to provide the transmit signal into the T/R switch 176. IP packets are transferred between the transceiver 182 and a mobile VoIP processor 188, which may be a BCM1161, also manufactured by Broadcom Corp.

In operation the received signal is amplified by the LNA 178 before it passes to the RX input of the transceiver 182. This additional amplification can provide the WLAN mobile phone 164 with a reception sensitivity of at least −97 dB, and down to about −100 dB. In a preferred embodiment the transceiver 182 is programmed to provide a signal at the terminal TX that has a variable output power. As a result, the power amplifier 186 provides a transmission signal output power range of between 14 and at least 25 dB, and up to about 28 dB. In an alternative embodiment the output power is kept constant rather than varying.

In the preferred embodiment the variable output power is automatically set to the lowest power that will provide a Quality of Service (QoS) for the WLAN mobile phone 164 that is commensurate with that of cellular phones. The power level can be determined by at least one of the characteristics commonly used in the art to evaluate the quality of the received signal. The use of the variable gain transmitting power both optimizes the life of the phone's battery and minimizes the RF interference generated by the WLAN mobile phone 164 to other users of the applicable frequency band.

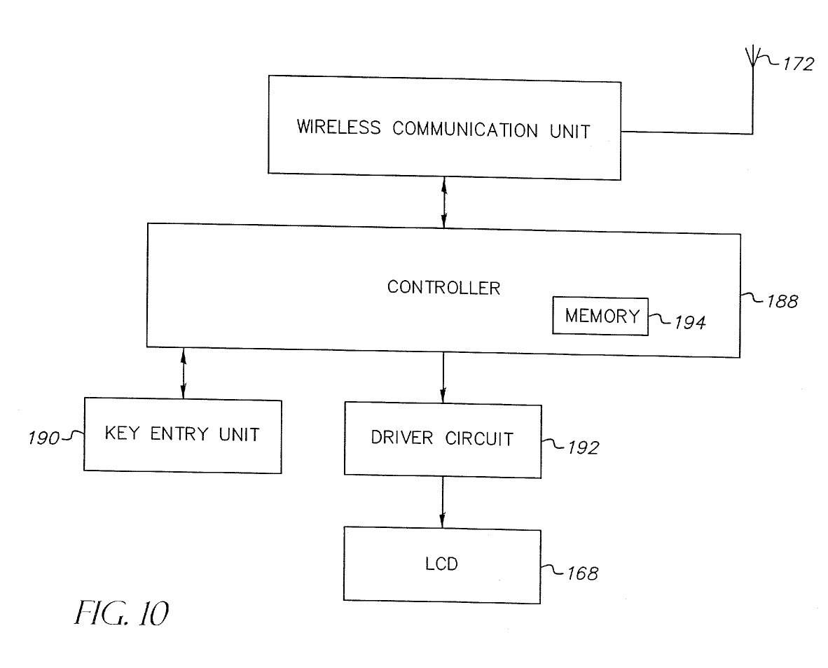

FIG. 10 is also a block diagram of a portion of the embodied WLAN mobile phone 164 shown in FIG. 8. The WLAN mobile phone 164 also includes the key pad 190 and a driver circuit 192 which drives the display 168. Phone features, including, for example, speed dialing, providing a list of received and called phone numbers, short message service (SMS), MMS, email, instant messaging, web browsing, and call muting, are provided by the software in the mobile VoIP processor 188. Many of these features are not found on currently available WLAN mobile phones.

The WLAN mobile phone 164 enables a user to select a list of preferred networks and the relative priority of each of the networks using the memory 194 to store the parameters for the networks. The WLAN phone user can choose any network that is available to the public. In contrast cellular phone subscribers have this feature available only when they roam on other networks if there is a pre-signed roaming agreement between the other network and their cellular service provider.

Moreover, the selection of a network, other than the default network, can be automatic. The user can pre-set a number of hot spot profiles to get connected automatically in places where the default network is not yet available. The pre-set profiles can be set according to the user's priority (first to search, second to search, etc.). The phone will search first for the default transceiver network. Then if this network does not exist, the phone will search for an available base station for each of the pre-set alternative networks in the order of their priority. In the case that none of the pre-set profiles is found, the phone goes to manual mode and will present the available SSIDs on the display 168. The user is then given the option to manually choose one and to set up a WLAN connectivity. After the WLAN connectivity is completed (either to the default network or to any other SSIDs) the phone registers with the core of the default network. This core provides the switch services and the connection to other networks: PSTN, cellular, International, and value added services such as voice mail service, SMS service, MMS, email, instant messaging, and web browsing, etc.

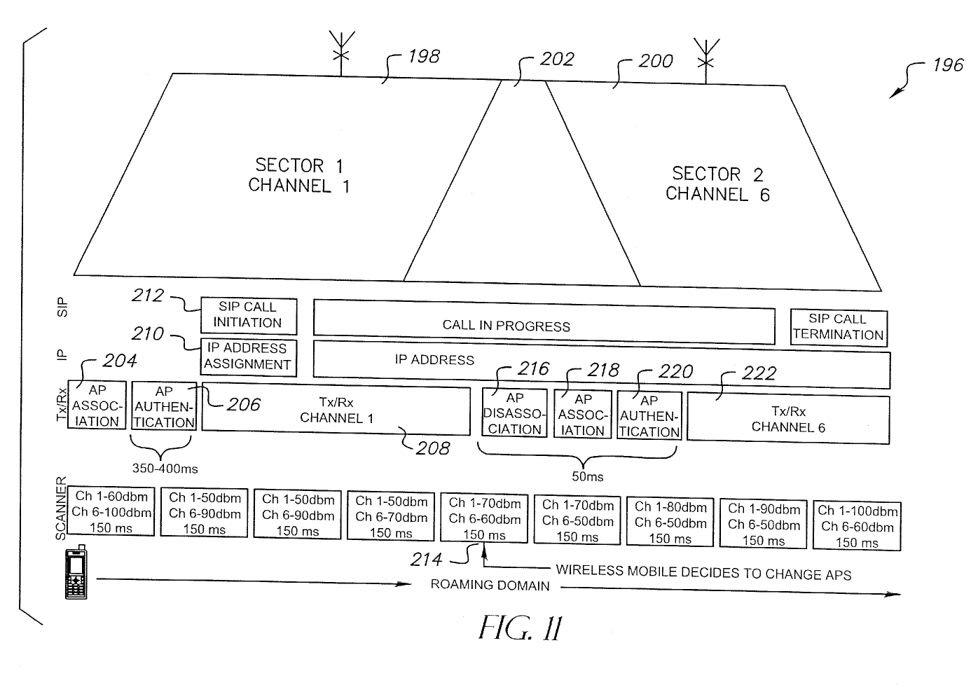

FIG. 11 illustrates one embodiment of a timing diagram 196 of a WLAN mobile phone 164 handoff process when the WLAN mobile phone 164 roams from one sector connection (or base station connection) to another sector connection (or another base station connection) within a network. At the top of FIG. 11 is a perspective view of a horizontal slice near a base station. A region 198 shows the area where the predominant signal strength is to and from a sector 1 and region 200 shows the area where the predominant signal strength is to and from a sector 2. The area 202 is the crossover region between the areas 198 and 200. In the example of FIG. 11 a WLAN mobile phone 164 initiates a telephone call with an AP association shown in block 204. After the AP association, an AP authentication occurs as shown in block 206. This initial authentication takes about 350 to 400 ms. Once the authentication is complete, normal voice transmission using sector 1 occurs as shown in block 208. Also, after the authentication, an IP address is assigned as shown in block 210 and a SIP call initiation occurs as shown in block 212. As shown in the bottom row of FIG. 11, as the WLAN mobile phone 164 travels, the signal strengths for sector 1 and sector 2 change. In a preferred embodiment the WLAN mobile phone 164 measures the signal strength from the surrounding sectors or base stations every two seconds, although other sampling intervals, regular or irregular, could be used in other embodiments.

When the WLAN mobile phone 164 senses that another sector has a signal which is greater than the current sector exceeded by a given threshold, for example 3 dB greater, as occurs at point 214, the WLAN mobile phone 164 stores the MAC address of sector 2, dissociates from sector 1 in this example as shown in block 216, associates with sector 2 as shown in block 218, authenticates with sector 2 as shown in block 220, and resumes normal communication as shown in block 222 using sector 2 instead of sector 1. Advantageously, the system of the related application named above keeps the IP address and SIP connection alive for one or two seconds after the WLAN mobile phone 164 disassociates so that the WLAN mobile phone 164 can re-associate and re-authenticate in about 50 ms which does not cause a disturbance noticeable to the user of the WLAN mobile phone 164. In other embodiments, the IP address and the SIP connection may be kept alive for different time periods. In this embodiment, the system also remembers the key used in the last connection for a few seconds so that the authentication and WEP/WPA-PSK/WPA/WPA2 encryption can be quickly reestablished.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A wireless network, comprising:
a plurality of base stations, each configured to communicate with at least one portable device using a wireless local area network (WLAN) protocol; and
a Voice-over-IP (VoIP) core network coupled to each of the base stations.

2. The wireless network of claim 1, wherein the WLAN protocol comprises an 802.11 protocol.

3. The wireless network of claim 1, wherein the WLAN protocol comprises a Bluetooth® protocol.

4. The wireless network of claim 1, wherein the base stations are configured to communicate with the at least one portable device using the WLAN protocol at a first frequency.

5. The wireless network of claim 4, wherein the first frequency comprises approximately 2.4 Ghz.

6. The wireless network of claim 1, wherein the at least one portable device comprises a WLAN mobile phone having a mobile antenna.

7. The wireless network of claim 6, wherein the WLAN mobile phone is selected from the group consisting of a WiFi mobile phone, an 802.11 mobile phone, and a Bluetooth® mobile phone.

8. The wireless network of claim 6, wherein the at least one portable device further comprises WWAN capabilities in addition to comprising a WLAN mobile phone.

9. The wireless network of claim 6, wherein the WLAN mobile phone comprises an RF section having a variable power transmitter, wherein transmission power is varied in response to at least one characteristic of signals received by the WLAN mobile phone.

10. The wireless network of claim 9, wherein the at least one characteristic of signals received by the WLAN mobile phone is selected from the group consisting of a signal strength, a retransmission rate, an error rate, a signal-to-noise determination, a data rate, and a congestion level.

11. The wireless network of claim 6, wherein the WLAN mobile phone comprises a VoIP processor configured to:
code analog voice data into outgoing digital packets for communication with the at least one base station; and
decode incoming digital voice packets received from communication with the at least one base station.

12. The wireless network of claim 11, wherein the VoIP processor is adapted to receive SMS data and display SMS data on a display coupled to the VoIP processor.

13. The wireless network of claim 11, wherein the VoIP processor is adapted to receive MMS data and display MMS data on a display coupled to the VoIP processor.

14. The wireless network of claim 11, wherein the VoIP processor is adapted to receive email data and display email data on a display coupled to the VoIP processor.

15. The wireless network of claim 11, wherein the VoIP processor is adapted to receive instant messaging data and display instant messaging data on a display coupled to the VoIP processor.

16. The wireless network of claim 11, wherein the VoIP processor is adapted to receive web browsing data and display web browsing data on a display coupled to the VoIP processor.

17. The wireless network of claim 11, wherein:
the at least one base station comprises a current base station which the WLAN mobile phone is currently associated with and an alternate base station which the WLAN mobile phone is not associated with;
the VoIP processor is coupled to the mobile antenna and configured to monitor a current signal strength from the current base station and an alternate signal strength from the alternate base station; and
the VoIP processor is configured to disassociate from the current base station when an analysis of the current signal strength and the alternate signal strength indicate that it would be better to associate with the alternate base station.

18. The wireless network of claim 17, wherein the analysis of the current signal strength and the alternate signal strength comprise comparing the current signal strength to the alternate signal strength to see if the alternate signal strength exceeds the current signal strength by a threshold.

19. The wireless network of claim 18, wherein the threshold is 3 dB.

20. The wireless network of claim 17, wherein the VoIP processor is further configured to store an alternate identifier for the alternate base station before disassociating from the current base station, so that the alternate identifier can be used to associate with the alternate base station.

21. The wireless network of claim 20, wherein the alternate identifier comprises a MAC address.

22. The wireless network of claim 1, wherein the VoIP core network is configured to:
assign an IP address to the at least one portable device, communicating with a first base station, following a first association by the portable device with the VoIP core network; and
maintain the IP address during a transition time following a subsequent disassociation by the portable device in order to allow the portable device to re-associate with the VoIP core network by communicating with a second base station without having to obtain a new IP address.

23. The wireless network of claim 22, wherein the VoIP core network communicates with the at least one portable device using a SIP protocol.

24. The wireless network of claim 22, wherein the VoIP core network is further configured to store a last encryption key used prior to the subsequent disassociation so that encryption can be established with reduced delay by re-using the stored encryption key during and/or after the portable device re-association.

25. The wireless network of claim 24, wherein the encryption key is compatible with the group consisting of WEP, WPA-PSK, WPA, and WPA2.

26. The wireless network of claim 1, further comprising at least one repeater, and wherein:
the base stations are configured to communicate with the at least one portable device using a first frequency band;
the at least one repeater is configured to communicate with the at least one portable device using the first frequency band; and
the at least one repeater is configured to communicate with at least one of the base stations using a second frequency band.

27. The wireless network of claim 26, wherein the first frequency band is different than the second frequency band.

28. The wireless network of claim 27, wherein:
the first frequency band comprises a 2.4 GHz frequency band; and
the second frequency band comprises a 5.8 GHz frequency band.

29. The wireless network of claim 1, wherein the VoIP core network further comprises a voice gateway for allowing communication between the at least one portable device and a voice network outside of the wireless network.

30. The wireless network of claim 29, wherein the voice network outside of the wireless network is selected from the group consisting of a PSTN, a PBX, and a cellular system.

31. The wireless network of claim 1, further comprising a fixed-line gateway in communication with at least one base station, the fixed line gateway configured to enable VoIP services for at least one fixed line phone.

32. The wireless network of claim 1, wherein the VoIP core network is coupled to at least one of the base stations by a wired connection.

33. The wireless network of claim 32, wherein the wired connection is selected from the group consisting of electrically conductive wires and at least one fiber optic wire.

34. The wireless network of claim 1, wherein the VoIP core network is coupled to at least one of the base stations by a wide area network.

35. The wireless network of claim 34, wherein the wide area network comprises the Internet.

36. The wireless network of claim 1, wherein the VoIP core network is coupled to at least one of the base stations by a local area network.

37. The wireless network of claim 36, wherein the local area network is a wireless local area network.

38. A wireless local area network (WLAN) mobile phone, comprising:
an antenna;
an RF section coupled to the antenna; and
a VoIP processor coupled to the RF section and configured to monitor a current signal strength from a current base station and an alternate signal strength from an alternate base station, wherein the VoIP processor is configured to disassociate from the current base station when an analysis of the current signal strength and the alternate signal strength indicate that it would be better to associate with the alternate base station.

39. The WLAN mobile phone of claim 38, wherein the analysis of the current signal strength and the alternate signal strength comprise comparing the current signal strength to the alternate signal strength to see if the alternate signal strength exceeds the current signal strength by a threshold.

40. The WLAN mobile phone of claim 39, wherein the threshold is 3 dB.

41. The WLAN mobile phone of claim 38, wherein the VoIP processor is further configured to store an alternate identifier for the alternate base station before disassociating from the current base station, so that the alternate identifier can be used to associate with the alternate base station.

42. The WLAN mobile phone of claim 41, wherein the alternate identifier comprises a MAC address.

43. The WLAN mobile phone of claim 38, wherein the RF section has an output power of at least 25 dB.

44. The WLAN mobile phone of claim 38, wherein the RF section comprises a receiving amplifier such that the reception sensitivity of the WLAN mobile phone is at least −97 dB.

45. The WLAN mobile phone of claim 38, wherein the VoIP processor is further configured to receive SMS data and display the SMS data on a display coupled to the VoIP processor.

46. The WLAN mobile phone of claim 38, wherein the VoIP processor is adapted to receive MMS data and display MMS data on a display coupled to the VoIP processor.

47. The WLAN mobile phone of claim 38, wherein the VoIP processor is adapted to receive email data and display email data on a display coupled to the VoIP processor.

48. The WLAN mobile phone of claim 38, wherein the VoIP processor is adapted to receive instant messaging data and display instant messaging data on a display coupled to the VoIP processor.

49. The WLAN mobile phone of claim 38, wherein the VoIP processor is adapted to receive web browsing data and display web browsing data on a display coupled to the VoIP processor.

50. The WLAN mobile phone of claim 38, wherein the RF section further comprises a variable power transmitter, the output power variation made in response to at least one characteristic of signals received by the WLAN mobile phone.

51. The WLAN mobile phone of claim 38, wherein the WLAN mobile phone is selected from the group consisting of a WiFi mobile phone, an 802.11 mobile phone, and a Bluetooth® mobile phone.

52. The WLAN mobile phone of claim 38, wherein the VoIP processor is further configured:
to store at least one parameter for one or more base stations; and
to select a preferred base station to communicate with from a set of available base stations based at least in part on the stored at least one parameter for the one or more base stations.

53. The WLAN mobile phone of claim 52, wherein the stored at least one parameter is entered or selected manually by a user of the WLAN mobile phone.

54. A method of handing-off a VoIP call-in-progress from a first base station to a second base station with reduced interruption in the voice communication, comprising:
determining that a call association should be changed from the first base station to the second base station;
storing identifying information about the second base station before disassociating from the first base station;
disassociating from the first base station;
maintaining an IP address assignment which was active when the call-in-progress was associated with the first base station;
associating with the second base station; and
communicating with the second base station using the maintained IP address assignment.

55. The method of claim 54, further comprising:
maintaining a peer-to-peer connection which was active when the call-in-progress was associated with the first base station.

56. The method of claim 55, wherein the peer-to-peer connection comprises a SIP Call.

57. The method of claim 54, further comprising remembering a last encryption key used so that the communicating action with the second base station can be reestablished with reduced delay.

58. The method of claim 57, wherein the encryption key comprises an encryption method selected from the group consisting of WEP, WPA-PSK, WPA, and WPA2.

59. The method of claim 54, wherein storing identifying information about the second base station before disassociating from the first base station comprises storing a MAC address of the second base station.

60. The method of claim 54, wherein determining that the call association should be changed from the first base station to the second base station comprises comparing a first signal strength of the first base station to the a second signal strength of the second base station to see if the second signal strength exceeds the first signal strength by a threshold.
